(19) United States
(12) Patent Application Publication
(10) Pub. No.: US 2025/0095163 A1
(43) Pub. Date: Mar. 20, 2025

(54) SYSTEMS AND METHODS FOR TRACKING AN INTERACTIVE OBJECT

(71) Applicant: Universal City Studios LLC, Universal City, CA (US)

(72) Inventors: Wei Cheng Yeh, Orlando, FL (US); Rachel Elise Rodgers, Orlando, FL (US)

(21) Appl. No.: 18/886,640

(22) Filed: Sep. 16, 2024

Related U.S. Application Data
(60) Provisional application No. 63/538,975, filed on Sep. 18, 2023.

(51) Int. Cl. G06T 7/20; G06T 7/70; G06T 13/40; G06V 10/141

(52) U.S. Cl. CPC G06T 7/20; G06T 7/70; G06T 13/40; G06V 10/141; G06T 2207/10048; G06V 2201/07

(57) ABSTRACT

An interactive object control system includes processing circuitry with one or more processors and memory storing instructions, that when executed by the processing circuitry cause the processing circuitry to send instructions to an interactive object to cause one or more object emitters of the interactive object to emit light; receive photodiode array data from one or more photodiode arrays, wherein the photodiode array data is indicative of detection of the light emitted by the one or more object emitters of the interactive object; determine a position of the interactive object in an interactive environment based on the photodiode array data; receive image data from one or more cameras; identify the interactive object in the image data based on the position of the interactive object in the interactive environment and an indication of reflected light in the image data.

### CROSS-REFERENCE TO RELATED APPLICATION

This application claims priority to and the benefit of U.S. Provisional Application No. 63/538,975, entitled “SYSTEMS AND METHODS FOR TRACKING AN INTERACTIVE OBJECT” and filed Sep. 18, 2023, which is incorporated by reference herein in its entirety for all purposes.

### BACKGROUND

This section is intended to introduce the reader to various aspects of art that may be related to various aspects of the present disclosure. This discussion is believed to be helpful in providing the reader with background information to facilitate a better understanding of the various aspects of the present disclosure. Accordingly, it should be noted that these statements are to be read in this light and not as admissions of prior art.

To improve guest experiences in an entertainment setting, the entertainment setting may often include objects (e.g., props or toys) that are interactive, provide special effects, or both. For example, the special effects may provide customized effects based on guests' experiences within the entertainment setting, as well as support a particular narrative in the entertainment setting. In certain interactive entertainment settings, guests may own or be associated with objects that interact with the interactive entertainment setting in various ways. In one example, a guest may wish to interact with the interactive entertainment setting using a handheld device (e.g., an object) to generate a particular special effect. However, such interactive entertainment settings are often crowded with multiple guests. Moreover, identifying objects within such interactive entertainment settings may be challenging when multiple guests are each carrying their own object.

### BRIEF DESCRIPTION

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below

In accordance with an embodiment, an interactive object control system includes processing circuitry with one or more processors and memory storing instructions, that when executed by the processing circuitry cause the processing circuitry to send instructions to an interactive object to cause one or more object emitters of the interactive object to emit light; receive photodiode array data from one or more photodiode arrays, wherein the photodiode array data is indicative of detection of the light emitted by the one or more object emitters of the interactive object; determine a position of the interactive object in an interactive environment based on the photodiode array data; receive image data from one or more cameras; identify the interactive object in the image data based on the position of the interactive object in the interactive environment and an indication of reflected light in the image data; track motion of the interactive object based on the image data; and provide output instructions to generate special effect outputs based on the motion of the interactive object.

In accordance with an embodiment, a method of operating an interactive object control system includes sending, using one or more processors, instructions to an interactive object to cause one or more object emitters of the interactive object to emit light; receiving, at the one or more processors, photodiode array data from one or more photodiode arrays, wherein the photodiode array data is indicative of detection of the light emitted by the one or more object emitters of the interactive object; determining, using the one or more processors, a position of the interactive object in an interactive environment based on the photodiode array data; receiving, at the one or more processors, image data from one or more cameras; identifying, using the one or more processors, the interactive object in the image data based on the position of the interactive object in the interactive environment and an indication of reflected light in the image data; tracking, using the one or more processors, motion of the interactive object based on the image data; and providing, using the one or more processors, output instructions to generate special effect outputs based on the motion of the interactive object.

In accordance with an embodiment, an interactive object control system includes an interactive object comprising one or more object emitters and one or more reflectors. The interactive object control system also includes processing circuitry with one or more processors and memory storing instructions, that when executed by the processing circuitry cause the processing circuitry to receive photodiode array data from one or more photodiode arrays, wherein the photodiode array data is indicative of detection of light emitted by the one or more object emitters of the interactive object; determine a position of the interactive object in an interactive environment based on the photodiode array data; receive image data from one or more cameras; identify the interactive object in the image data based on the position of the interactive object in the interactive environment and an indication of reflected light reflected by the one or more reflectors in the image data; track motion of the interactive object based on the image data; provide output instructions to generate special effect outputs based on the motion of the interactive object.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an embodiment of an interactive object control system, in accordance with present techniques;

FIG. 2 is a schematic illustration of hardware of an embodiment of the interactive object control system of FIG. 1, in accordance with present techniques; and

FIG. 3 is a flow diagram of a method for detecting an interactive object, in accordance with present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. One or more specific embodiments of the present embodiments described herein will be described below. In an effort to provide a concise description of these embodiments, all features of an actual implementation may not be described in the specification. It should be noted that in the development of any such actual implementation, as in any engineering or design project, numerous implementation-specific decisions must be made to achieve the developers' specific goals, such as compliance with system-related and business-related constraints, which may vary from one implementation to another. Moreover, it should be noted that such a development effort might be complex and time consuming, but would nevertheless be a routine undertaking of design, fabrication, and manufacture for those of ordinary skill having the benefit of this disclosure.

Users (e.g., guests) in an interactive environment (e.g., an immersive experience or an entertainment setting) may enjoy carrying or wearing objects (e.g., props; guest objects; interactive objects). The objects be associated with a theme and/or may include any of a variety of handheld and/or wearable objects, such as a sword, wand, token, medallion, headgear, figurine, stuffed animal, clothing (e.g., hat), jewelry (e.g., necklace, bracelet, band), other portable object, or any combination thereof.

As described herein, the objects may be utilized to facilitate interactions with the interactive environment. For example, certain movements of an object may be detected as an input that can initiate a special effect (e.g., special effect outputs; display of imagery, such as animated characters; lighting; sounds; and/or haptic effects). Such interactions in the interactive environment may generally involve detection or recognition of the object inside the interactive environment (e.g., with a sensor and/or via wireless communication), as well as control of the object and/or special effect features (e.g., components) of the interactive environment based on the detection or recognition of the object inside the interactive environment. In some cases, the control of the object and/or the special effect features of the interactive environment may be based on the detection or recognition of a pattern associated with the object (e.g., movement or operation of the object). Further, in some cases, the object may be associated with a user profile, such that aspects of the interactions may be linked to the user profile. The user profile may include various types of user profile information, such as accomplishments (e.g., achievements), including accomplishments due to actions performed by one or more users in the interactive environment and/or actions carried out using the object; user experience levels; past user locations; past object locations; past user experiences; user preferences, such as preferred characters and/or preferred colors; user information, such as age and/or height. In an embodiment, the accomplishments may include a total of points awarded and saved to the user profile, such as due to the actions performed by the one or more users in the interactive environment and/or actions carried out using the object. In an embodiment, the special effects may be based on the user profile. It should be appreciated that the user profile may be associated with one or more users that utilize the object, for example.

Present embodiments relate generally to an interactive object control system associated with the interactive environment. The interactive object control system may include a controller (e.g., electronic controller; processing circuitry) that may receive various types of data, such as photodiode array data, imager data (e.g., images or imagery), and/or image data (e.g., camera images or imagery; infrared (IR) camera images or imagery). The controller may process the data to identify an object and to track movement of the object within the interactive environment, and the controller may also initiate the special effects based on the object and/or the movement of the object within the interactive environment. In an embodiment, the controller may process the data (e.g., to identify light patterns in the image data) to associate the object with a user profile. In an embodiment, the controller may be coupled to a radiofrequency identification (RFID) reader, such that the data may include an identifier of the object (e.g., read from a RFID tag of the object) to enable the controller to associate the object with the user profile. It should be appreciated that the controller may be coupled to another type of reader or communication circuitry that is capable of reading another type of readable code, such as an alphanumeric code, bar code, quick response (QR) code to enable the controller to associate the object with the user profile.

A photodiode array may generate the photodiode array data indicative of light emitted by an emitter of the object. Further, the photodiode array data may be indicative of a position of the emitter of the object in the interactive environment. In an embodiment, a grid (e.g., virtual grid; 4×4 grid, 8×8 grid, 16×16 grid) may be mapped to the interactive environment (e.g., real-world environment), and the photodiode array data may be indicative of the position of the emitter of the object relative to the grid. For example, the photodiode array data may be indicative of the position of the emitter of the object relative to the grid, such as an approximate position or coordinates, such as an X (row) and Y (column) coordinate within the grid). A camera (e.g., IR camera) may generate the image data indicative of light (e.g., IR light) reflected by a reflector of the object. Further, the image data may be indicative of movement of the object in the interactive environment (e.g., the light reflected by the reflector of the object is tracked over time via the camera). As described in more detail herein, the photodiode array and the camera may be utilized together to efficiently identify the object and track the object in the interactive environment, even when multiple objects are present in the interactive environment.

In an embodiment, an imager (e.g., optical sensor or camera) may be utilized to generate the imager data indicative of the light emitted by the emitter of the object. Further, the imager data may be indicative of the position of the emitter of the object in the interactive environment (e.g., approximate position or coordinates in the grid mapped to the interactive environment). As described in more detail herein, the imager and the camera may be utilized together to efficiently identify the object and track the object in the interactive environment, even when multiple objects are present in the interactive environment. It should be appreciated that the imager may be used instead of the photodiode array, such as to provide a camera-based system. However, the imager may be used in addition to the photodiode array, such as to obtain additional information. In an embodiment, the imager data may be processed at the imager, and then the imager may provide limited data (e.g., the position and not raw images) to another processor to enable tracking of the object via the image data.

In operation, multiple objects may be carried into the interactive environment. Presence of the multiple objects may be detected by the imager, the camera, wireless communication between the multiple objects and a communication device coupled to the controller (e.g., the RFID reader), or any combination thereof. The controller may identify a best candidate object (e.g., a single object) among the multiple objects based on respective communication signals between the multiple objects and the communication device coupled to the controller. For example, the controller may identify the best candidate object among the multiple objects based on respective received signal strengths of the communication signals between the multiple objects and the communication device coupled to the controller (e.g., the best candidate object has a highest signal strength). In an embodiment, the communication signals may also provide respective object identification information for each of the multiple objects, which may be used by the controller to retrieve respective user profiles associated with each of the multiple objects.

Then, the controller may send operational instructions to the best candidate object. The operational instructions may include instructions to activate an emitter on the best candidate object to cause the emitter to emit light. The photodiode array and/or the imager may detect the light, and thus, the best candidate object. As described herein, the photodiode array data and/or the imager data may be indicative of the position of the best candidate object in the interactive environment. Thus, the controller may analyze the image data with reference to the position of the best candidate object to thereby track movement of the best candidate object. In particular, the controller may analyze the image data with reference to the position of the best candidate object to identify the light in the image data that is likely due to reflection by a reflector of the best candidate object to thereby track the movement of the best candidate object. Advantageously, the photodiode array and/or the imager in combination with the camera may provide efficient (e.g., low latency) identification of the position of the best candidate object and tracking of the best candidate object (e.g., compared to use of the camera alone).

The interactive environment may be part of a venue, such as an entertainment venue (e.g., an amusement park, a theatre, a sports stadium), a retail establishment, a residential building, a school, and so forth. In an embodiment, the interactive environment may be a live show, where the users are in an audience and may be able to participate in the live show using the objects. In an embodiment, the interactive environment may be a walk-through attraction or a ride attraction, whether users travel to experience different scenes and may be able to interact with the different scenes using the objects. Further, the interactive environment may include different locations that are geographically separated from one another or that are dispersed throughout the venue. The interactive environment may also be in a remote location. For example, each user may be able to establish the interactive environment at their home or any other location via an electronic device associated with the user (e.g., user electronic device; home console) that may interact with the object.

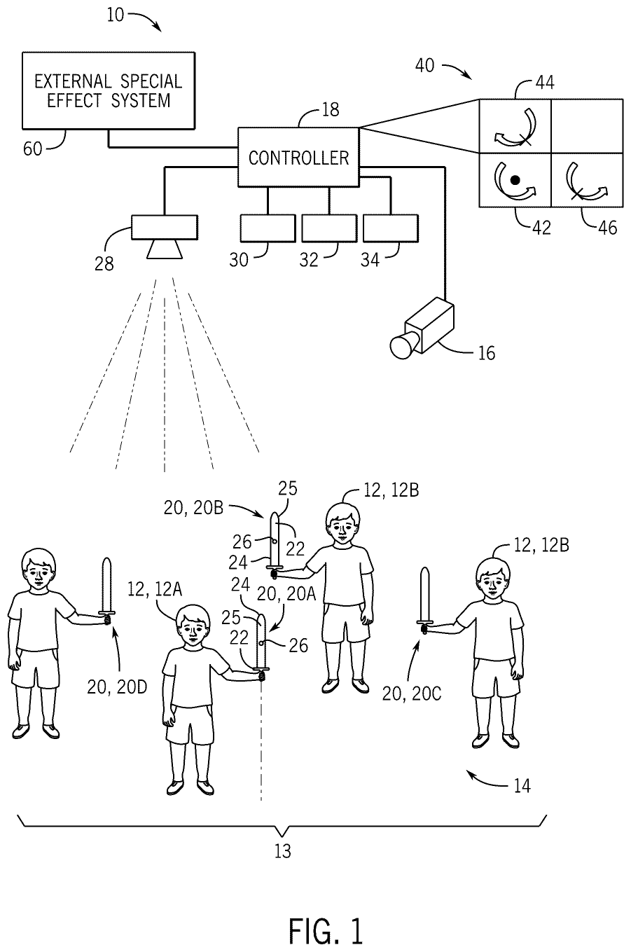

FIG. 1 is a schematic illustration of an embodiment of an interactive object system 10. In one embodiment, the interactive object system 10 may be associated with an interactive environment 14 and may be used to detect one or more interactive objects 20 in the interactive environment 14. The interactive environment 14 may include an area 13 (e.g., interactive area) proximate to (e.g., within a communication range or line-of-sight of) one or more cameras 16 (e.g., IR cameras, visible light cameras, capable of detecting any particular or suitable wavelength of light), one or more emitters 28 (e.g., IR light emitters, visible light emitters, capable of emitting any particular or suitable wavelength of light), one or more photodiode arrays 30, and/or one or more communication devices 32.

In one embodiment, one or more users 12 may carry (e.g., hold and/or wear) the one or more interactive objects 20 in the interactive environment 14. For example, multiple users 12 and multiple interactive objects 20 may be present in the interactive environment 14, wherein each of the one or more users 12 carries a respective interactive object 20 (e.g., a first user 12A carries a first interactive object 20A, a second user 12B carries a second interactive object 20B, and so on). Each of the one or more interactive objects 20 may include a housing 22 that supports various components, such as an object communication device 24 (e.g., communication circuitry; radio frequency identification (RFID) tag) that stores and transmits an identifier (e.g., unique identification code) to the one or more communication devices 32 (e.g., communication circuitry; a RFID reader). The housing 22 may also support an object emitter 25 and/or a detectable marker 26.

In operation with a single interactive object 20 in the area 13 (and thus, the single interactive object 20 is a best candidate interactive object in the area 13), the object communication device 24 may provide a unique identifier for the single interactive object 20 to the one or more communication devices 32. The one or more communication devices 32 may provide the unique identifier to a controller 18, and the controller 18 may retrieve or access a user profile associated with the unique identifier (e.g., from a database). The controller 18 may send an object-specific command based on the user profile to cause the single interactive object 20 to emit light via the object emitter 25 (e.g., the object-specific command to the first interactive object 20A would cause the object emitter 25 of the first interactive object 20A to emit light, but would not cause the object emitter 25 of the second interactive object 20B to emit light). Then, if the one or more photodiode arrays 30 detects the light emitted by the object emitter 25 and generates photodiode array data accordingly, then the controller 18 may utilize the photodiode array data to determine (e.g., confirm) that the single interactive object 20 in the area 13 is properly identified and associated with the user profile. Thus, any special effects provided in the interactive environment 14 during operation of the single interactive object 20 in the area 13 may account for details in the user profile. For example, the special effects may be based on user profile information, such as accomplishments (e.g., achievements), including accomplishments due to actions performed by one or more users in the interactive environment 14 and/or actions carried out using the single interactive object 20; user experience levels; past user locations; past object locations; past user experiences; user preferences, such as preferred characters and/or preferred colors; user information, such as age and/or height. In an embodiment, the accomplishments may include a total of points awarded and saved to the user profile, such as due to the actions performed by the one or more users in the interactive environment 14 and/or actions carried out using the single interactive object 20. For example, the special effects may include display of certain characters preferred by the user according to the user profile. Additionally, accomplishments (e.g., points) awarded due to actions within the interactive environment 14 may be saved to the user profile, and thus, the user profile may be updated over time. As shown, the interactive object system 10 may include an external special effect system 60, which may provide special effects (e.g., special effect outputs). The special effects may include displayed outputs, audio outputs, lighting outputs, flame effects, animated figures, and so forth. For example, the displayed outputs may include display of media, such as characters, scenery, and so forth. As another example, the animated figures may include actuatable characters and/or objects that include actuators to drive movement of the animated figures (or portions thereof) relative to the interactive environment 14.

Further, the photodiode array data may indicate a position of the single interactive object 20 in the area 13. For example, the position may include an approximate position or coordinates in a grid mapped to the area 13, such as an X (row) and Y (column) coordinate within a 4×4 grid, 8×8 grid, 16×16 grid, and so on (e.g., each photodiode of the one or more photodiode arrays may be assigned to and/or correspond to a respective portion or cell of the grid). In an embodiment, the object emitters 25 may be multi-frequency light emitters and may emit light over different and/or multiple ranges of wavelengths (e.g., IR wavelength ranges and/or visible light wavelength ranges; 750 to 800 nm, 900 to 1000 nm), which may facilitate detection and confirmation of the single interactive object 20. In an embodiment, a filter (e.g., bandpass filter) may be associated with (e.g., placed in front of) the one or more photodiode arrays 30 to block certain wavelengths of light. For example, the filter may permit wavelengths of approximately 750 to 1000 nanometers (nm), 770 to 950 nm, 780 to 940 nm, 750 to 800 nm, 900 to 1000 nm, and/or any other suitable wavelengths or wavelength ranges to pass through the filter to be detected by the one or more photodiode arrays 30. In an embodiment, the one or more photodiode arrays 30 include a lens (e.g., focuser) to align and/or to overlap a respective field of view of the one or more photodiode arrays 30 with a respective field of view of the one or more cameras 16. Such features may facilitate calibrating the one or more photodiode arrays 30 and the one or more cameras 16 (e.g., both relative to the grid, which generally represents or provides a shared reference and/or a shared coordinate system) to facilitate use of the position derived based on the detection of the light by the one or more photodiode arrays 30 for tracking the single interactive object 20 in the interactive environment 14.

The one or more emitters 28 may emit light within any suitable range of wavelengths (e.g., IR wavelength range and/or visible light wavelength range) that corresponds to a retroreflector wavelength range of the detectable markers 26 of the one or more interactive objects 20, including the detectable marker 26 of the single interactive object 20. For example, the wavelength range may include wavelengths of approximately 800 to 1100 nm. In an embodiment, the one or more emitters 28 may be multi-frequency light emitters and may emit light over different and/or multiple wavelength ranges (e.g., IR wavelength ranges and/or visible light wavelength ranges; 800 to 850 nm, 900 to 1100 nm), which may facilitate detection and tracking of multiple interactive objects 20. In an embodiment, the one or more emitters 28 and the object emitters 25 may emit light over different wavelength ranges (e.g., 800 to 850 nm and/or 960 to 1100 nm for the one or more emitters 28, and 750 to 790 nm and/or 900 to 950 nm for the object emitters 25) to facilitate differentiation of various light emissions. In cases where the one or more emitters 28 and the object emitters 25 emit light in overlapping wavelength ranges, the controller 18 may provide instructions to emit the light from the one or more emitters 28 and the object emitters 25 at different times (e.g., turn off the one or more emitters 28 temporarily (e.g., turn off for one or more milliseconds) to enable detection of the light emitted by the object emitters 25).

In the example with the single interactive object 20, the one or more cameras 16 may generate image data indicative of the light reflected by the detectable marker 26 of the single interactive object 20. Further, the image data may be indicative of movement of the single interactive object 20 in the interactive environment 14 (e.g., the light reflected by the detectable marker 26 of the single interactive object 20 is tracked over time via the one or more cameras 16). For example, the image data may indicate that the single interactive object 20 moved in a swirl pattern, a swipe motion, an up and down motion, and so forth. Because the controller 18 received the unique identification code and the photodiode array data indicative of the position of the single interactive object 20 in the interactive environment 14, the controller 18 may efficiently and reliably (e.g., with a high level of confidence, as compared to systems that track without features disclosed herein) track the single interactive object 20 in the interactive environment 14, identify successful or complete gestures or movements performed with the single interactive object 20, assign achievements to the user profile and/or otherwise update the user profile, provide personalized special effects based on the user profile, and so forth.

Importantly, the interactive object system 10 may enable the controller 18 to track the single interactive object 20 even with additional interactive objects 20 in the area 13 (e.g., within the field of view of the one or more cameras 16). For example, even if the additional interactive objects 20 enter the area 13 and reflect the light toward the one or more cameras 16, the controller 18 will continue to identify and separately track the reflections (e.g., a trail of reflections during motion) from the single interactive object 20 since the single interactive object 20 has been initially associated with a portion of the grid and/or tagged in the image data based on the position derived from the photodiode array data. For example, the single interactive object 20 may be tagged in the image data by labeling a reflection as being associated with (e.g., caused by; originating at) the single interactive object 20, such that ongoing or future reflections (e.g., trail; consecutive reflections) may be appropriately and accurately linked to (e.g., attributed to) the single interactive object 20.

Further, the interactive object system 10 may enable the controller 18 to also track one or more of the additional interactive objects 20 in the area 13 (e.g., within the field of view of the one or more cameras 16; simultaneously and/or sequentially track multiple interactive objects 20). For example, if multiple interactive objects 20 are in the area 13, the one or more communication devices 32 may communicate with each of the multiple interactive objects 20 (e.g., any of the multiple interactive objects 20 within communication range). Thus, the controller 18 may obtain, via the one or more communication devices 32, respective unique identifiers for each of the multiple interactive objects 20. The controller 18 may use the respective unique identifiers to retrieve or access respective user profiles. The controller 18 may select or designate a best candidate interactive object (e.g., the first interactive object 20A or the second interactive object 20B) of the multiple interactive objects 20, such as based on a signal strength of respective communications signals between the multiple interactive objects 20 and the one or more communication devices 32 (e.g., to select a highest strength signal, indicative of proximity to a desirable location to carry out interactions) and/or based on aspects of the respective user profiles (e.g., to select a user profile with particular user profile information, such as particular achievements).

Then, the controller 18 may send the object-specific command based on the user profile associated with the best candidate interactive object to cause the best candidate interactive object to emit light via the object emitter 25. Then, if the one or more photodiode arrays 30 detects the light emitted by the object emitter 25 and generates photodiode array data accordingly, then the controller 18 may utilize the photodiode array data to determine (e.g., confirm) that the best candidate interactive object in the interactive environment 14 is appropriately identified and associated with the user profile. Thus, any special effects provided in the interactive environment 14 during operation of the best candidate interactive object in the interactive environment 14 may account for details in the user profile, such as accomplishments awarded due to actions within the interactive environment 14 and/or other user profile information disclosed herein. It should be noted that if the one or more photodiode arrays 30 does not detect expected light emissions (e.g., the light expected to be emitted by the object emitter 25) and generate the photodiode array data accordingly, the controller 18 may utilize the photodiode array data to determine that the best candidate interactive object in the interactive environment 14 may not be appropriately identified and may not be properly associated with the user profile.

Further, if the one or more photodiode arrays 30 detects the light emitted by the object emitter 25, the photodiode array data may indicate a position of the best candidate interactive object in the interactive environment 14. For example, the position may include the approximate position or coordinates in the grid mapped to the area 13. Additionally, the one or more emitters 28 may emit light within any suitable wavelength range to cause reflection from the detectable markers 26 of the one or more interactive objects 20, including the detectable marker 26 of the best candidate interactive object. The one or more cameras 16 may generate image data indicative of the light reflected by the detectable markers 26 of the one or more interactive objects 20, including the detectable marker 26 of the best candidate interactive object. Further, the image data may be indicative of movement of the one or more interactive objects 20, including the best candidate interactive object. Because the controller 18 received the unique identification code and the photodiode array data indicative of the position of the best candidate interactive object in the interactive environment 14, the controller 18 may efficiently and reliably track the best candidate interactive object (e.g., tagged in the image data based on the position derived from the photodiode array data), identify successful or complete gestures or movements performed with the best candidate interactive object, assign accomplishments to the user profile and/or otherwise update the user profile information in the user profile, provide personalized special effects based on the user profile, and so forth.

It should be appreciated that the interactive object system 10 may enable the controller 18 to sequentially identify and designate best candidate interactive objects to thereby track multiple interactive objects 20 in the area 13 (e.g., within the field of view of the one or more cameras 16). For example, based on the unique identifier of the first interactive object 20A, the controller 18 may provide the object-specific command to cause the first interactive object 20A to emit light via the object emitter 25 of the first interactive object 20A. Then, upon detection of the light by the one or more photodiode arrays 30, the controller 18 may utilize the photodiode array data to determine the position of the first interactive object 20A in the interactive environment 14. Additionally, with information about the position of the first interactive object 20A, the controller 18 may tag the first interactive object 20A in the image data to track the first interactive object 20A in the interactive environment 14. As noted herein, this may be based on the photodiode array data that indicates the position of the first interactive object 20A (e.g., each photodiode corresponds to a portion of the grid).

After providing the object-specific command to cause the first interactive object 20A to emit light via the object emitter 25 of the first interactive object 20A and based on the unique identifier of the second interactive object 20B, the controller 18 may provide the object-specific command to cause the second interactive object 20B to emit light via the object emitter 25 of the second interactive object 20B. Then, upon detection of the light by the one or more photodiode arrays 30, the controller 18 may utilize the photodiode array data to determine the position of the second interactive object 20B in the interactive environment 14. Additionally, with information about the position of the second interactive object 20B, the controller 18 may tag the second interactive object 20B in the image data to track the second interactive object 20B in the interactive environment 14. As noted herein, this may be based on the photodiode array data that indicates the position of the second interactive object 20B (e.g., each photodiode corresponds to a portion of the grid). The interactive object system 10 may carry out these steps to identify and track additional interactive objects 20.

For example, with reference to exemplary grid 40, the controller 18 may determine that the first interactive object 20A is in a first portion 42 (e.g. cell) of the grid 40 based on the light emitted by the object emitter 25 of the first interactive object 20A (e.g., based on the photodiode array data). Thus, the controller 18 may associate the reflected light originating in the first portion 42 of the grid 40 with the first interactive object 20A, and the controller 18 may not associate the reflected light originating in other portions (e.g., cells) of the grid 40 with the first interactive object 20A. Further, in an embodiment, the controller 18 may determine that the second interactive object 20B is in a second portion 44 of the grid 40 based on the light emitted by the object emitter 25 of the second interactive object 20B (e.g., based on the photodiode array data). Thus, the controller 18 may associate the reflected light originating in the second portion 44 of the grid 40 with the second interactive object 20B, and the controller 18 may not associate the reflected light originating in other portions of the grid 40 with the second interactive object 20B. For example, the reflected light originating in a third portion 46 of the grid 40 may be due to presence of and light from a third interactive object 20C. However, the controller 18 may disregard the reflected light originating in the third portion 46 of the grid 40 if the third interactive object 20C has not yet been identified and/or tagged (e.g., based on the photodiode array data) by the interactive object system 10. Further, a fourth interactive object 20D may be located outside of the area 13 (e.g., outside of the field of view of the one or more photodiode arrays 30 and/or the one or more cameras 16), and thus, the fourth interactive object 20D may not be tracked and/or may not be included in the image data.

It should be appreciated that variations are envisioned. For example, in an embodiment, a single photodiode may be utilized to detect light emitted by the interactive objects 20 (e.g., instead of the one or more photodiode arrays 30). The single photodiode may generate photodiode data indicative of the light emitted by the interactive objects 20 (e.g., confirmation of the light), but the single photodiode may not provide information related to the positions of the interactive objects 20. However, the confirmation of the light may be sufficient to carry out tracking in certain circumstances, such as when the interactive environment 14 is designed to have only one interactive object 20 at a time (e.g., sufficient to confirm the user profile associated with the one interactive object 20) and/or other appropriate circumstances.

Further, it should be appreciated that certain steps may be carried out simultaneously and/or at overlapping times. For example, the controller 18 may provide the object-specific command for the first interactive object 20A and the one or more photodiode arrays 30 may detect the light emitted by the object emitter 25 of the first interactive object 20A (e.g., turn on for one or more milliseconds), then the controller 18 may provide the object-specific command for the second interactive object 20B and the one or more photodiode arrays 30 may detect the light emitted by the object emitter 25 of the second interactive object 20B (e.g., turn on for one or more milliseconds), and so on. During these processes, the one or more cameras 16 may also generate the image data indicative of motions performed by the multiple interactive objects 20 in the area 13 of the interactive environment 14. Then, the controller 18 may consider the photodiode array data and the image data together to assign certain motions (e.g., including motions that have already occurred and/or that occur during the object-specific commands and/or generation of the photodiode array data) to certain interactive objects 20 and/or to track additional motions, as described herein. For example, for a particular detected motion (e.g., each detected motion and/or completed gesture in the area 13) according the image data, the controller 18 may provide the object-specific command (e.g., based on the communication signals, such as signal strength, that indicate a most likely or best candidate object). Then, if the one or more photodiode arrays 30 detects the light emitted by the object emitter 25 (and provides this indication to the controller 18), the controller 18 may then activate the special effects according to the user profile and/or assign the accomplishment to the user profile.

In an embodiment, the one or more photodiode arrays 30 may enable transfer of encoded information via the light emitted by the object emitters 25 of the one or more interactive objects 20. For example, the object-specific commands may instruct emission of the light with certain sequences (e.g., on/off patterns) and/or certain wavelengths to facilitate detection of the light and/or confirmation of correct identification of the one or more interactive objects 20 (e.g., to link to the user profile). In some such cases, the controller 18 may dynamically determine the object-specific commands (e.g., the object-specific commands instruct ten different sequences and/or wavelengths for ten different interactive objects 20). In an embodiment, the object-specific commands may instruct emission of the light, and each of the one or more interactive objects 20 may be programmed to provide certain sequences (e.g., associated with the user profile) to facilitate detection of the light and/or confirmation of correct identification of the one or more interactive objects 20. In some such cases, individual users within a group of users (e.g., a family; a group traveling through the interactive environment 14 together) may be assigned to or provided with multiple interactive objects 20 that are programmed to provide different sequences and/or wavelengths. In an embodiment, the one or more photodiode arrays 30 are capable of identifying the sequences and/or the wavelengths (e.g., operate as wavelength detectors) to thereby provide additional confirmation and reliability (e.g., to confirm that a measured wavelength of the light matches an expected wavelength of the light for the respective interactive object 20).

In an embodiment, the one or more photodiode arrays 30 may include multiple photodiode arrays (e.g., 64×64 or other sufficient number) to facilitate tracking of respective motion of the one or more interactive objects 20 with the one or more photodiode arrays 30. In such cases, the image data may be complemented with the photodiode array data (e.g., the image data and the photodiode array data are used together for tracking purposes) or replaced by the photodiode array data (e.g., the interactive object system 10 may be devoid of the one or more cameras 16 and utilize the one or more photodiode arrays 30 for position and tracking purposes). In at least some such cases, appropriate filter(s) may be utilized with the one or more photodiode arrays 30 to enable the one or more photodiode arrays 30 to detect active light (e.g., emitted by the object emitters 25) as well as passive light (e.g., reflected by the detectable markers 26).

In an embodiment, the one or more photodiode arrays 30 may be complemented with or replaced by one or more imagers 34. In such cases, the one or more imagers 34 may generate imager data (e.g., image data) indicative of respective positions of the one or more interactive objects 20 (e.g., relative to a grid, such as the grid 40; X (row), Y (column), and/or Z (depth) coordinates). The respective positions of the one or more interactive objects 20 as determined based on the one or more imagers 34 and the imager data may be utilized in addition to or in lieu of the respective positions of the one or more interactive objects 20 as determined based on the one or more photodiode arrays 30 and the photodiode array data.

Advantageously, in an embodiment, the imager data may be processed at the one or more imagers (e.g., via one or more processors on-board the one or more imagers). Thus, with such edge processing, the controller 18 may receive the respective positions of the one or more interactive objects 20 (e.g., instead of the imager data; the respective positions of the one or more interactive objects 20 may be determined without the image data). This may support efficient identification and tracking by the controller 18 via cross-referencing the coordinates of the respective positions with the image data (e.g., low latency; avoiding delays due to transmission of the imager data (e.g., as raw data) and/or instead of the controller 18 receiving and processing both the imager data and the image data (e.g., both as raw data)).

The one or more imagers may be configured to capture light on/off information, rather than information encoded in the light (e.g., patterns; subject to noise and/or limited by refresh rate). However, in an embodiment, the one or more imagers may operate at sufficient refresh rate (e.g., frames per second) to enable detection of the information encoded in the light, as described herein. In an embodiment, the one or more imagers may scan the area 13 (or appropriate field of view) to detect the light emitted by the object emitters 25 of the one or more interactive objects 20. Further, the one or more imagers may have a field of view that aligns and/or overlaps with the one or more cameras 16 to facilitate techniques described herein.

It should be appreciated that certain interactive objects 20 (e.g., referred to herein as “passive interactive objects”) may not include the object emitters 25. In such cases, the controller 18 may identify the motion of the passive interactive object based on the image data (e.g., in one portion of the grid 40), and may also identify that no position information has been provided by the one or more photodiode arrays 30 (or the one or more imagers). Accordingly, the controller 18 may temporarily operate in a passive mode to provide appropriate special effects based on the motion of the passive interactive object based on the image data (e.g., display a character in response to detection of a completed gesture, but the character may not be personalized based on a user profile associated with the passive interactive object).

In an embodiment, the interactive object system 10 may facilitate dynamic calibration for accurate and/or precise tracking. For example, upon identifying the first interactive object 20A in the first portion 42 of the grid 40, the controller 18 may instruct the one or more cameras 16 to zoom in and/or effectively expand the first portion 42 of the grid 40 to a full view for analysis of the movement of the first interactive object 20A. In this way, the controller 18 may account for height differences and/or detect fine gestures with more precision. As another example, the controller 18 may utilize the information to provide efficient processing, such as by dynamically transitioning to consider more concentrated data (e.g., a subset of pixels) in the image data, for example. As another example, based on the movement of the first interactive object 20A in the first portion 42 of the grid 40, the controller 18 may assess sizes of gestures (e.g., relatively small, as in move through a relatively small portion of the area 13). In such cases, the controller 18 may normalize for future gestures, which may enable appropriate special effects regardless of sizes of the gestures (e.g., the controller 18 may activate the appropriate special effects even for children, who may perform relatively small gestures; a half gesture may be counted as a full gesture as a result of calibration/normalization). Accordingly, the controller 18 may carry out the calibration/normalization to shift location (e.g., within the grid 40) and/or to scale (e.g., make larger or smaller) for analysis.

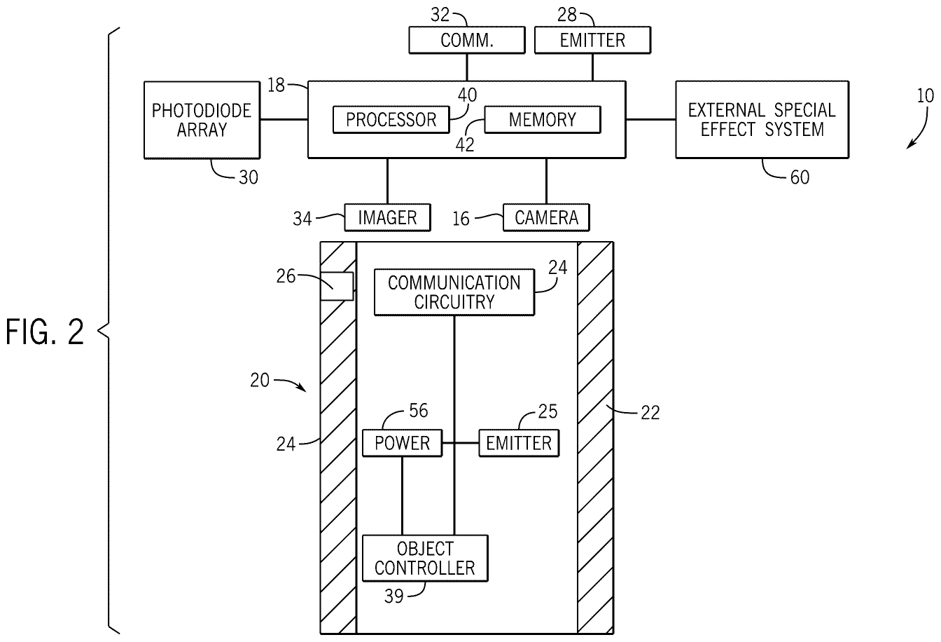

FIG. 2 is a schematic diagram of the interactive object system 10 demonstrating communication between the one or more interactive objects 20 and various components of the interactive object system 10 external to the one or more interactive objects 20. Disclosed techniques for tracking the one or more interactive objects 20 as provided herein may utilize the one or more cameras 16 that provide tracking motion of the one or more interactive objects 20, as well as one or more photodiode arrays 30 (and/or one or more images) that provide location information.

As described herein, in operation, with a single interactive object 20, the object communication device 24 may provide a unique identifier for the single interactive object 20 to the one or more communication devices 32. The one or more communication devices 32 may provide the unique identifier to the controller 18, and the controller 18 may retrieve or access a user profile associated with the unique identifier. The controller 18 may send the object-specific command based on the user profile to cause the single interactive object 20 to emit light via the object emitter 25. Then, if the one or more photodiode arrays 30 detects the light emitted by the object emitter 25 and generates photodiode array data accordingly, then the controller 18 may utilize the photodiode array data to determine that the single interactive object 20 in the interactive environment 14 is appropriately identified and associated with the user profile. Thus, special effects (e.g., special effect outputs) provided via an external special effect system 60 may account for details in the user profile. For example, the special effects may be based on user profile information, such as accomplishments (e.g., achievements), including accomplishments due to actions performed by one or more users in the interactive environment 14 and/or actions carried out using the single interactive object 20; user experience levels; past user locations; past object locations; past user experiences; user preferences, such as preferred characters and/or preferred colors; user information, such as age and/or height. In an embodiment, the accomplishments may include a total of points awarded and saved to the user profile, such as due to the actions performed by the one or more users in the interactive environment 14 and/or actions carried out using the single interactive object 20. For example, the special effects may include display of certain characters preferred by the user according to the user profile and/or display of favorite color according to the user profile. Additionally, accomplishments (e.g., points) awarded due to actions within the interactive environment 14 may be saved to the user profile, and thus, the user profile may be updated over time. Further, the photodiode array data may indicate a position of the single interactive object 20 in the interactive environment 14 (e.g., presence within a particular grid location as determined based on detection by an associated photodiode).

Additionally, the controller 18 may instruct the one or more emitters 28 to emit light within any suitable wavelength range that corresponds to a retroreflector wavelength range of the detectable markers 26 of the one or more interactive objects 20, including the detectable marker 26 of the single interactive object 20. In the example with the single interactive object 20, the one or more cameras 16 may generate image data indicative of the light reflected by the detectable marker 26 of the single interactive object 20. Further, the image data may be indicative of movement of the single interactive object 20 in the interactive environment 14 (e.g., the light reflected by the detectable marker 26 of the single interactive object 20 is tracked over time via the one or more cameras 16). For example, the image data may indicate that the single interactive object 20 moved in a swirl pattern, a swipe motion, an up and down motion, and so forth. Because the controller 18 received the unique identification code and the photodiode array data indicative of the position of the single interactive object 20 in the interactive environment 14, the controller 18 may efficiently and reliably track the single interactive object 20 in the interactive environment 14, identify successful or complete gestures or movements performed with the single interactive object 20, assign accomplishments to the user profile and/or otherwise update the user profile, provide personalized special effects (e.g., special effect outputs) via the external special effect system 60 based on the user profile, and so forth.

Importantly, the interactive object system 10 may enable the controller 18 to track the single interactive object 20 even when proximate to additional interactive objects 20 (e.g., within the field of view of the one or more cameras 16). For example, even if the additional interactive objects 20 reflect the light toward the one or more cameras 16, the controller 18 will continue to identify and separately track the reflections (e.g., a trail of reflections during motion) from the single interactive object 20 since the single interactive object 20 has been initially tagged in the image data based on the position derived from the photodiode array data.

As shown, an object controller 39 may control other components of the single interactive object 20. For example, the object controller 39 may control the object emitter 25, which may be powered either passively (e.g., via power harvesting) or actively (e.g., by a power source 56). In the depicted embodiment, the object communication device 24 may emit a wireless signal that communicates object identification information via a RFID tag, an infrared light signal, or the like.

It should be appreciated that the controller 18 may include one or more processors 50 and one or more memory devices 52. The one or more processors 50 may include one or more application specific integrated circuits (ASICs), one or more field programmable gate arrays (FPGAs), one or more general purpose processors, or any combination thereof. Additionally, the one or more memory devices 52 may include volatile memory, such as random access memory (RAM), and/or non-volatile memory, such as read-only memory (ROM), optical drives, hard disc drives, or solid-state drives. The controller 18 may include one or more controllers (e.g., in the interactive environment 14) that communicate with each other through the use of a wireless mesh network (WMN) or other wireless and/or wired communication methods.

The controller 18 may be part of a distributed decentralized network of one or more controllers. The decentralized network of the one or more controllers may facilitate reduction in processing time and processing power required for the one or more controllers dispersed throughout one or more interactive environments 14. The decentralized network of the one or more controllers may be configured to obtain user profiles by requesting the user profiles from a profile feed stored in a central server. The user profile feed may include user accomplishments and/or other user profile information disclosed herein. The one or more controllers 18 may act as edge controllers that subscribe to a profile feed including multiple user profiles stored in the central server and cache the profile feed to receive one or more user profiles contained in the profile feed.

As described herein, additional controller(s) and/or processor(s) may be associated with (e.g., located on; housed within) the one or more cameras 16, the one or photodiode arrays 30, the one or more imagers, and/or other components. The additional controller(s) and/or processor(s) may facilitate edge processing to reduce latency, reduce power usage, and so forth. Together, the controller 18 (which may include one or more controllers), the processor 50 (e.g., which may include one or more processors), the memory device 52 (e.g., which may include one or more memory devices), the network of one or more controllers in the decentralized network, and/or the respective object controllers 39 on the one or more interactive objects 20 may carry out processing operations to carry out the techniques disclosed herein. It should be appreciated that “processing circuitry” and/or “control circuitry” as used herein may refer to any combination of these control and/or processing components, and the processing operations may be distributed in any suitable manner (e.g., one or more operations carried out by one processor of the processing circuitry, one or more other operations carried out by another processor of the processing circuitry, and so forth).

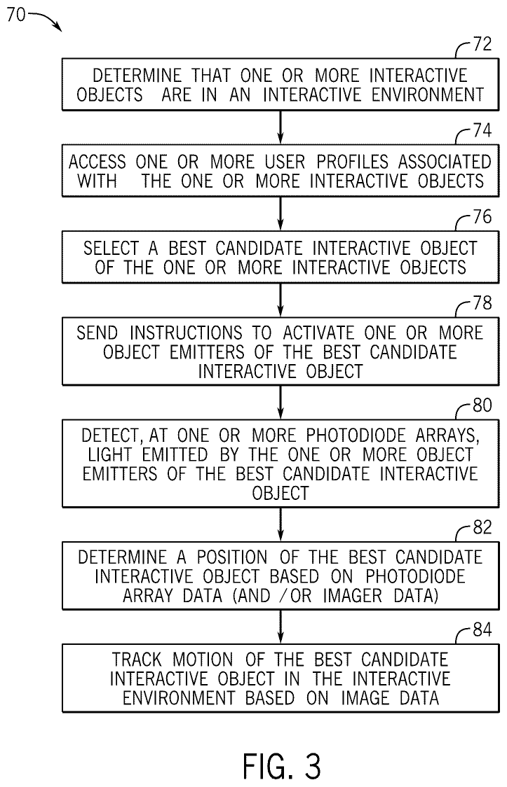

FIG. 3 is a flow diagram of an embodiment of a method 70 for tracking one interactive object of one or more interactive objects, in accordance with present techniques. It should be appreciated that steps of the method 70 may be carried out by processing circuitry, such as the controller 18 of FIG. 2. It should also be appreciated that blocks of the method 70 may be carried out in any order, certain blocks of the method 70 may be omitted, and/or additional blocks may be added to the method 70. For example, the method 70 may be carried out without block 72, such as by proceeding with accessing one or more user profiles for the one or more interactive objects 20 that are present and/or providing object-specific commands to cause light emissions, for example.

As shown, in block 72, the method 70 may begin with determining that one or more interactive objects are within an interactive environment. This may be based on communication between communication circuitry (e.g., RFID tag) of the one or more interactive objects and communication circuitry (e.g., RFID reader) coupled to a controller. In an embodiment, this may be based on detection of light (e.g., IR light) at one or more cameras (e.g., IR cameras), wherein the light is reflected by one or more detectable markers of the one or more interactive objects toward the one or more cameras.

In block 74, the method 70 may continue with accessing one or more user profiles associated with the one or more interactive objects 20. This may be based on the unique identifiers provided via the communication, characteristics of the light emitted by the one or more object emitters 25 and/or light reflected by the one or more detectable markers, or any combination thereof. The one or more user profiles may be retrieved from a database, and the one or more user profiles may include accomplishments and/or other user profile information disclosed herein.

In block 76, the method 70 may continue with selecting a best candidate interactive object of the one or more interactive objects 20. This may be based on the one or more user profiles, characteristics of the communication (e.g., signal strength), or any combination thereof. In block 78, the method 70 may continue with sending an object-specific command to activate one or more object emitters 25 of the best candidate interactive object of the one or more interactive objects 20. The object-specific command may be based on the unique identifier of the best candidate interactive object of the one or more interactive objects 20 (e.g., to address or activate only the best candidate interactive object).

In block 80, the method 70 may continue with detecting light emitted by the one or more object emitters 25 of the best candidate interactive object of the one or more interactive objects 20. In particular, this may include detecting the light at one or more photodiode arrays. In block 82, the method 70 may continue with determining a position of the best candidate interactive object in the interactive environment based on photodiode array data generated by the one or more photodiode arrays. For example, the photodiode array date may indicate the position of the best candidate interactive object in a grid that is mapped to the interactive environment and/or that overlaps with a field of view of one or more cameras. Specifically, for example, a particular photodiode in the photodiode array may be aimed at a particular location and detection by the particular photodiode may indicate presence of the detected object in the particular location (e.g., correlated to or corresponding with a portion of cell of the grid mapped to the interactive environment).

In block 84, the method 70 may continue with tracking motion of the best candidate interactive object based on image data generated by the one or more cameras. For example, the position of the best candidate interactive object may be used to tag and confirm the best candidate interactive object in the image data. Then, one or more emitters in the interactive environment may emit light (e.g., IR light), which is then reflected by a detectable marker of the best candidate interactive object. Analysis of the image data over time may indicate the motion of the best candidate interactive object (e.g., trails formed via reflection of the light indicate gestures or motions of the best candidate interactive object).

As described herein, the one or more images may be utilized to detect the light emitted by the one or more object emitters (as part of block 80). In such cases, the position of the best candidate interactive object may be based on imager data (as part of block 82).

It should be appreciated that the techniques to identify the interactive object of the one or more interactive objects may be triggered by detection of performance of a gesture by at least one of the one or more interactive objects (e.g., in response to receipt of signals from the one or more cameras that indicate performance of the gesture, such as a waving movement through space). Thus, if one of the users moves their interactive object of the one or more interactive objects to perform the gesture (any of a suite of recognized gestures), the interactive object control system may then retrieve and/or analyze identification information, signal strength information, and so forth to carry out blocks 72-82 of the method 70, for example.

It should be appreciated that various wavelengths of light, different combinations of wavelengths of light, and so forth may be utilized to carry out detecting and tracking techniques described herein. For example, the one or more object emitters may emit visible light, while the one or more emitters may emit IR light (and the detectable markers may reflect the IR light for detection by the one or more cameras, which are one or more IR cameras capable of generating the image data indicative of the IR light). As another example, the one or more object emitters may emit IR light within a first range of wavelengths, while the one or more emitters may emit IR light within a second range of wavelengths that is different from the first range of wavelengths. As another example, the one or more object emitters may emit IR light within a first range of wavelengths, while the one or more emitters may emit IR light within the first range or within a second range of wavelengths that overlaps with the first range of wavelengths. In such cases, signals and/or information related to emissions from the one or more object emitters and the one or more emitters may controlled via timing signals and/or interpreted in view of timing signals. As another example, the one or more object emitters may emit IR light, while the one or more emitters may emit visible light. Indeed, it should be appreciated that any suitable combination of light emitters, photodiodes/photodiode arrays, light detectors, cameras, filters, and so forth may be provided to utilize light emissions and detections for detecting and tracking objects.

While only certain features of the invention have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ” it is intended that such elements are to be interpreted under 35 U.S.C. 112(f). However, for any claims containing elements designated in any other manner, it is intended that such elements are not to be interpreted under 35 U.S.C. 112(f).

1. An interactive object control system, comprising:
processing circuitry comprising one or more processors; and
memory storing instructions, that when executed by the processing circuitry, cause the processing circuitry to:
send instructions to an interactive object to cause one or more object emitters of the interactive object to emit light;
receive photodiode array data from one or more photodiode arrays, wherein the photodiode array data is indicative of detection of the light emitted by the one or more object emitters of the interactive object;
determine a position of the interactive object in an interactive environment based on the photodiode array data;
receive image data from one or more cameras;
identify the interactive object in the image data based on the position of the interactive object in the interactive environment and an indication of reflected light in the image data;
track motion of the interactive object based on the image data; and
provide output instructions to generate special effect outputs based on the motion of the interactive object.

2. The interactive object control system of claim 1, wherein the image data from the one or more cameras comprises infrared (IR) image data from one or more IR cameras.

3. The interactive object control system of claim 1, wherein the instructions, when executed by the processing circuitry, cause the processing circuitry to determine the position of the interactive object relative to a grid mapped to the interactive environment based on the photodiode array data, wherein the grid overlaps with a field of view of the one or more cameras.

4. The interactive object control system of claim 1, wherein the instructions, when executed by the processing circuitry, cause the processing circuitry to adjust a field of view of the one or more cameras based on the position of the interactive object.

5. The interactive object control system of claim 1, wherein the instructions, when executed by the processing circuitry, cause the processing circuitry to provide the output instructions to the one or more object emitters to generate the special effect outputs based on the motion of the interactive object.

6. The interactive object control system of claim 1, wherein the instructions, when executed by the processing circuitry, cause the processing circuitry to provide the output instructions to a special effect system in the interactive environment to generate the special effect outputs based on the motion of the interactive object.

7. The interactive object control system of claim 1, wherein the instructions, when executed by the processing circuitry, cause the processing circuitry to receive identification data from an identifier from the interactive object, and to access a profile associated with the interactive object based on the identifier.

8. The interactive object control system of claim 7, wherein the identifier comprises one or more characteristics of the light emitted by the one or more object emitters, additional light reflected by one or more object reflectors of the interactive object, one or more radiofrequency (RFID) tags, one or more readable codes, or any combination thereof.

9. The interactive object control system of claim 7, wherein the instructions, when executed by the processing circuitry, cause the processing circuitry to send the instructions to the interactive object as object-specific instructions based on the profile to cause the one or more object emitters of the interactive object to emit the light.

10. The interactive object control system of claim 8, wherein the instructions, when executed by the processing circuitry, cause the processing circuitry to:
determine a wavelength of the light based on the photodiode array data; and
compare the wavelength of the light to an expected light in the profile to confirm that the interactive object is associated with the profile.

11. The interactive object control system of claim 7, wherein the instructions, when executed by the processing circuitry, cause the processing circuitry to provide the output instructions to the one or more object emitters generate the special effect outputs based on the motion of the interactive object and the profile.

12. The interactive object control system of claim 7, wherein the instructions, when executed by the processing circuitry, cause the processing circuitry to provide the output instructions to a special effect system in the interactive environment to generate the special effect outputs based on the motion of the interactive object and the profile.

13. The interactive object control system of claim 1, comprising the interactive object, wherein the interactive object comprises a handheld object or a wearable object.

14. The interactive object control system of claim 1, comprising one or more filters positioned between the one or more photodiode arrays to block one or more wavelengths of light.

15. A method of operating an interactive object control system, the method comprising:
sending, using one or more processors, instructions to an interactive object to cause one or more object emitters of the interactive object to emit light;
receiving, at the one or more processors, photodiode array data from one or more photodiode arrays, wherein the photodiode array data is indicative of detection of the light emitted by the one or more object emitters of the interactive object;
determining, using the one or more processors, a position of the interactive object in an interactive environment based on the photodiode array data;
receiving, at the one or more processors, image data from one or more cameras;
identifying, using the one or more processors, the interactive object in the image data based on the position of the interactive object in the interactive environment and an indication of reflected light in the image data;
tracking, using the one or more processors, motion of the interactive object based on the image data; and
providing, using the one or more processors, output instructions to generate special effect outputs based on the motion of the interactive object.

16. The method of claim 15, comprising adjusting, using the one or more processors, a field of view of the one or more cameras based on the position of the interactive object.

17. The method of claim 15, comprising:
receiving, at the one or more processors, an identifier from the interactive object; and
accessing, using the one or more processors, a profile associated with the interactive object based on the identifier.

18. The method of claim 17, comprising:
sending, using the one or more processors, the instructions to the interactive object as object-specific instructions based on the profile to cause the one or more object emitters of the interactive object to emit the light;
determining, using the one or more processors, a wavelength of the light based on the photodiode array data; and
comparing, using the one or more processors, the wavelength of the light to an expected light in the profile to confirm that the interactive object is associated with the profile.

19. The method of claim 15, comprising:
detecting, using the one or more processors, presence of a plurality of interactive objects in the interactive environment, wherein the plurality of interactive objects comprises the interactive object as a first interactive object of the plurality of interactive objects;
identifying, using the one or more processors, the first interactive object of the plurality of interactive objects as a best candidate object of the plurality of interactive objects in the interactive environment; and
sending, using the one or more processors and in response to identifying the first interactive object of the plurality of interactive objects as the best candidate object of the plurality of interactive objects, the instructions to the first interactive object of the plurality of interactive objects as object-specific instructions based on the identifier to cause the one or more object emitters of the first interactive object of the plurality of interactive objects to emit the light without causing any respective object emitters of a remainder of the interactive objects of the plurality of interactive objects to emit respective light.

20. An interactive object control system, comprising:
an interactive object comprising one or more object emitters and one or more reflectors;
processing circuitry comprising one or more processors; and
memory storing instructions, that when executed by the processing circuitry, cause the processing circuitry to:
receive photodiode array data from one or more photodiode arrays, wherein the photodiode array data is indicative of detection of light emitted by the one or more object emitters of the interactive object;
determine a position of the interactive object in an interactive environment based on the photodiode array data;
receive image data from one or more cameras;
identify the interactive object in the image data based on the position of the interactive object in the interactive environment and an indication of reflected light reflected by the one or more reflectors in the image data;
track motion of the interactive object based on the image data; and
provide output instructions generate special effect outputs based on the motion of the interactive object.

21. The interactive object control system of claim 20, wherein the instructions, when executed by the processing circuitry, cause the processing circuitry to:
receive identification data from an identifier from the interactive object;
access a profile associated with the interactive object based on the identifier; and
send object-specific instructions to the interactive object based on the profile to cause the one or more object emitters of the interactive object to emit the light.

22. The interactive object control system of claim 21, wherein the instructions, when executed by the processing circuitry, cause the processing circuitry to:
determine a wavelength of the light based on the photodiode array data; and
compare the wavelength of the light to an expected light in the profile to confirm that the interactive object is associated with the profile.

23. The interactive object control system of claim 20, wherein the instructions, when executed by the processing circuitry, cause the processing circuitry to provide output instructions to a special effect system in the interactive environment to generate the special effect outputs based on the motion of the interactive object.
